(19) United States
(12) Patent Application Publication
(10) Pub. No.: US 2005/0207519 A1
(43) Pub. Date: Sep. 22, 2005

(54) Digital radio receiver

(76) Inventors: Piao Chun Phang, Singapore (SG); Boon Kiat Poh, Singapore (SG)

Correspondence Address: QUARLES & BRADY LLP, 411 E. WISCONSIN AVENUE, SUITE 2040, MILWAUKEE, WI, 53202-4497, US

(21) Appl. No.: 11/081,379

(22) Filed: Mar. 16, 2005

(30) Foreign Application Priority Data
Mar. 19, 2004 (SG) 200401529-3

(51) Int. Cl. H04L 27/06

(52) U.S. Cl. 375/354; 375/368

(57) ABSTRACT

A digital radio receiver is disclosed herein. The receiver substitutes a phase offset compensator with a simple and cost-effective structure for the conventional carrier recovery unit which is relatively complex and expensive, so as to decrease the complexity of the receiver and to provide cost savings. The digital radio receiver includes means arranged to filter and timing recover a received signal to produce timing corrected symbols; means arranged to differentially detect the timing corrected symbols; means arranged to compensate a phase offset of the detected symbol; and decoding means arranged to decode the phase offset compensated symbols into a bit stream.

### FIELD OF THE INVENTION

This present invention relates to a digital radio receiver for use in M-ary differential phase shift keying (MDPSK) demodulation and Continuous Pulse demodulation schemes.

### BACKGROUND OF THE INVENTION

Radio-communication systems transmit of information over an air interface by modulating the radio frequency (RF) carrier with information sources. When the signal is received, the receiver attempts to extract the original information therefrom by adopting an appropriate demodulation technique. Demodulating digitally-modulated signals entails the use of an estimated replica of the received carrier frequency for recovering the signal. In an ideal situation, the transmitter generates a carrier signal that exists at some known carrier frequency. The received signals are then demodulated at the receiver using the same known frequency. However, inaccuracies in the oscillators of the transmitter and receiver and the effect of Doppler shifting lead to carrier frequency offsets which make this approach infeasible. If the frequency offset is excessive and not adequately compensated, the performance of the demodulator will invariably be degraded to an extent that the original information cannot be reliably recovered.

In order to reduce the impact of frequency offset on receiver performance, some form of carrier frequency offset compensation technique is typically employed. In a well-known method, a carrier-recovery loop such as a carrier-tracking-loop is used to recover a reference carrier for demodulation. Based on the principle of a phase-locked-loop (PLL), the carrier-tracking-loop continuously tracks the received carrier phase for frequency offset compensation. Although the PLL can track out the carrier phase offset, it should be noted that carrier phase offset compensation is not as critical for differential modulation schemes such the M-ary Differential-Phase-Shift-Keying (MDPSK) used in the present invention. This is because in differential modulation the information is encoded in terms of phase changes between adjacent symbols instead of the absolute phase of the symbols.

This carrier-recovery-loop technique can be found in numerous references such as the “METHOD AND APPARATUS FOR PROVIDING CARRIER FREQUENCY OFFSET COMPENSATION IN A TDMA COMMUNICATION SYSTEM, U.S. Pat. No. 5,245,611, 14 Sep. 1993”, “A 70-MB/S VARIABLE-RATE 1024-QAM CABLE RECEIVER IC WITH INTEGRATED 10-B ADC AND FEC DECODER, IEEE JOURNAL OF SOLID-STATE CIRCUITS, VOL 33, NO 12, December 1998” and “A SINGLE-CHIP UNIVERSAL CABLE SET-TOP TOP BOX/MODEM TRANSCEIVER, IEEE JOURNAL OF SOLID-STATE CIRCUITS, VOL 34, NO 11, November 1999”.

Although quite effective in reducing the carrier frequency offset of a received signal, the PLL based technique is fairly complex as it involves the design of a Numerically Controlled Oscillator (NCO) for sinusoidal waveform generation. For example, the NCO is typically designed using the Direct Digital Synthesis (DDS) technology which requires a large Look-Up-Table (LUT) in the form of ROM (Read-Only-Memory) for maintaining signal fidelity. Another simpler NCO implementation known as the Coordinate Rotation Digital Computer (CORDIC) may be used to generate the reference carrier by an iterative process. Depending on the required accuracy, the iteration time may be too long, thereby contributing to longer PLL loop delay and causing potential instability. Furthermore, the PLL based technique is highly susceptible to input signal amplitude fluctuation and can degrade the overall receiver performance.

Another well-known technique for carrier offset compensation is the use of frequency estimation scheme. Unlike PLL based method, this “feed-forward” technique typically performs a one-shot estimation (based on a fixed number of symbols) of the received frequency offset. The frequency estimate is then used to directly set the local reference carrier (NCO or VCO) to match the received frequency. Due to the limited observation interval during the estimation process and the absence of a feedback-tracking loop, the estimates are usually not accurate and therefore the compensated signal still suffers from residual frequency offset. In additional, a NCO is needed for waveform generation.

This frequency estimation technique is addressed in a paper by Umberto Mengali entitled “Data Aided Frequency Estimation for Burst Digital Transmission” (IEEE TRANSACTION ON COMMUNICATIONS, Vol 45, No 1, January 1997).

FIG. 1 is a block diagram of a receiver of the prior art. In FIG. 1, the received signal is filtered by a matched-filter (also known as pulse shaping filter) for enhancing the Signal-to Noise ratio (SNR) and to reduce the influence of any out-of-band interference on the receiver performance. In a M-ary Differential-Phase-Shift-Keying (MDPSK) modulation scheme such as the one used in the present invention, filters at both the transmitter and the receiver normally employ square-root-raised-cosine (SRRC) filters to achieve a composite Raised-Cosine Filter characteristic. Such filters not only meet the mandatory spectral mask requirement of a particular communication standard but also allow the transmitted symbols to be recovered with negligible Inter-Symbol-Interference (ISI).

During the Analog to Digital conversion process, the received symbols are usually not sampled at the optimum points and the resultant timing-offset will induce ISI causing performance degradation. Even if the sampling process is optimal, the transmitter and receiver clocks can drift in time due to a number of causes such as oscillator aging effects, and the inherent frequency inaccuracy (due to manufacturing variation). To mitigate this potential problem, a timing recovery module is employed to recover the transmitted symbols so that they are matched to the transmitting clock in both frequency and phase.

At the output of the timing recovery module, the symbols still suffer from carrier phase offset existing in the neighboring symbols. The subsequent carrier recovery module attempts to remove this offset. As mentioned before, this module typically employs PLL or frequency estimation techniques to compensate for the carrier phase offset.

Since the output from the timing recovery module involves a rotating carrier phase offset, which is usually mathematically represented as e^{jΔωt}, the phase offset compensation by the carrier recovery module is difficult to implement.

Due to the potential implementation complexity of the traditional carrier phase-offset compensation schemes, it would be highly advantageous to replace them with a simpler alternative.

It would be desirable to decrease the complexity and cost of the receiver by replacing the relatively complex and expensive conventional carrier recovery unit with a phase offset compensator having a simpler, more cost-effective structure.

### SUMMARY OF THE INVENTION

In accordance with the present invention, there is provided a digital radio receiver, comprising: means arranged to filter and timing recover a received signal into timing corrected symbols; means arranged to differentially detect the timing corrected symbols; means arranged to compensate a phase offset of the detected symbol; and means arranged to decode the phase offset compensated symbols into bit stream.

In one exemplary embodiment, the means arranged to compensate a phase offset comprises: a pattern-matching detector, a phase offset tracker and a multiplier, wherein, the pattern-matching detector triggers the phase offset tracker on detecting a pattern-matching between the bit stream and a pre-stored bit pattern; the phase offset tracker calculates an average value of the phase offset; and the multiplier multiplies the detected symbol with the average value of the phase offset to yield the phase offset compensated symbol. The pattern-matching detector comprises: a first multiplexer, a correlator, a peak detector, a control unit, wherein, the first multiplexer selects pre-stored preamble bits or sync bits under control of the control unit; the correlator correlates the bit stream with the selected bits and yields an output representing the number of correlated bits; the peak detector compares the output from the correlator with a programmable threshold and triggers the control unit if the output is above the programmable threshold; and the control unit outputs a preamble detect indicator to trigger the phase offset tracker and controls the first multiplexer to output the selected bits to the phase offset tracker.

In another exemplary embodiment, the means arranged to compensate comprises: a phase-matching detector, a phase offset tracker and a multiplier, wherein, the pattern-matching detector triggers the phase offset tracker on detecting a pattern-matching between the phase offset compensated symbols and a pre-stored symbol pattern; the phase offset tracker calculates an average value of the phase offset; and the multiplier multiplies the detected symbol with the average value of the phase offset to yield the phase offset compensated symbol. The phase-matching detector comprises: a first multiplexer, a sliding correlator, a peak detector, a control unit, wherein, the first multiplexer select pre-stored preamble bits or sync bits under control of the control unit; the correlator correlates the phase offset compensated symbols with the selected bits and yield an output representing the number of correlated bits; the peak detector compares the output from the correlator with a programmable threshold and trigger the control unit if the output is above the programmable threshold; and the control unit outputs a preamble detect indicator to trigger the phase offset tracker and controls the first multiplexer to output the selected bits to the phase offset compensator.

The present invention provides a phase offset compensator with simpler structure and cost-effectiveness to replace the conventional carrier recovery unit, which is relatively complex and expensive, so as to decrease the complexity of the receiver, and hence reduce cost.

### BRIEF DESCRIPTION OF THE DRAWINGS

Embodiments of the invention will now be discussed, by way of example, with reference to the accompanying drawings, in which:

FIG. 1 is a schematic block diagram illustrating the structure of a receiver of the prior art;

FIG. 2 shows a packet format of a signal received by a receiver of the present invention;

FIG. 3 schematically illustrates a first embodiment of a receiver of the present invention;

FIG. 4 schematically illustrates an example of a timing recovery loop of the receiver of FIG. 3;

FIG. 5 schematically illustrates the structure of a timing error detector of the timing recovery loop shown in FIG. 4;

FIG. 6 schematically illustrates the structure of a loop filter of the timing recovery loop shown in FIG. 4;

FIG. 7 schematically illustrates the structure of a controller of the timing recovery loop shown in FIG. 4;

FIG. 8 schematically illustrates another example of a timing recovery loop of the receiver shown in FIG. 3;

FIG. 9 schematically illustrates the structure of a differential detector of the receiver of FIG. 3;

FIG. 10 schematically illustrates the structure of a phase-offset tracker of the receiver of FIG. 3;

FIG. 11 schematically illustrates the structure of a pattern-matching detector of the receiver of FIG. 3;

FIG. 12a depicts the bit error rate (BER) performance of the system of the present invention using π/2-DBPSK modulation scheme;

FIG. 12b depicts the bit error rate (BER) performance of the system of the present invention using π/4-DBPSK modulation scheme;

FIG. 12c depicts the bit error rate (BER) performance of the system of the present invention using π/8-DBPSK modulation scheme;

FIG. 13 schematically illustrates a second embodiment of a receiver of the present invention;

FIG. 14 schematically illustrates the structure of a phase-matching detector of the receiver shown in FIG. 13; and

FIG. 15 schematically illustrates the structure of a sliding correlator of the phase-matching detector shown in FIG. 14.

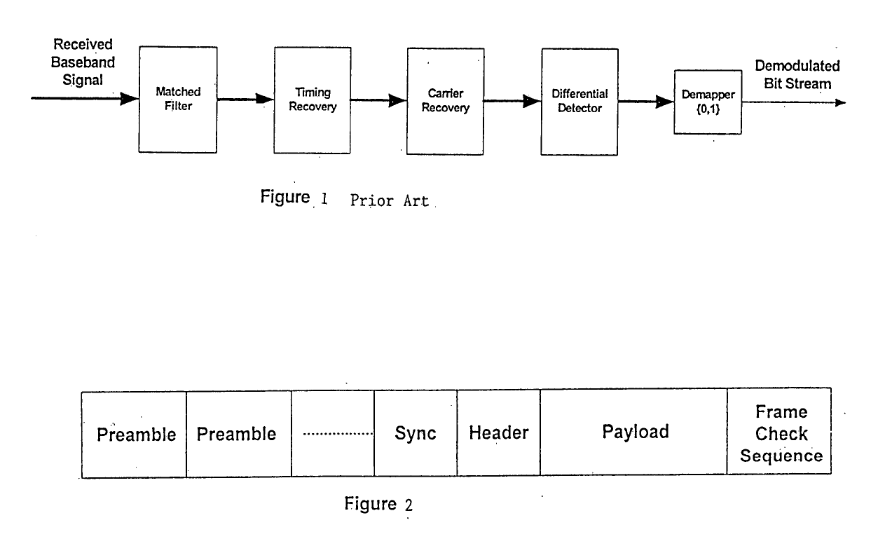

### DETAILED DESCRIPTION OF THE PREFERRED EMBODIMENTS OF THE INVENTION

### First Embodiment

FIG. 2 shows a packet format of a signal received by a receiver of the present invention. It comprises repetitive preamble sequences to aid the receiver algorithms for Automatic Gain Controlled (AGC) control, timing recovery, phase-offset recovery and signal equalization. A Synchronization Pattern (Sync) is also included to aid frame synchronization so that relative positions of Header and Payload can be determined.

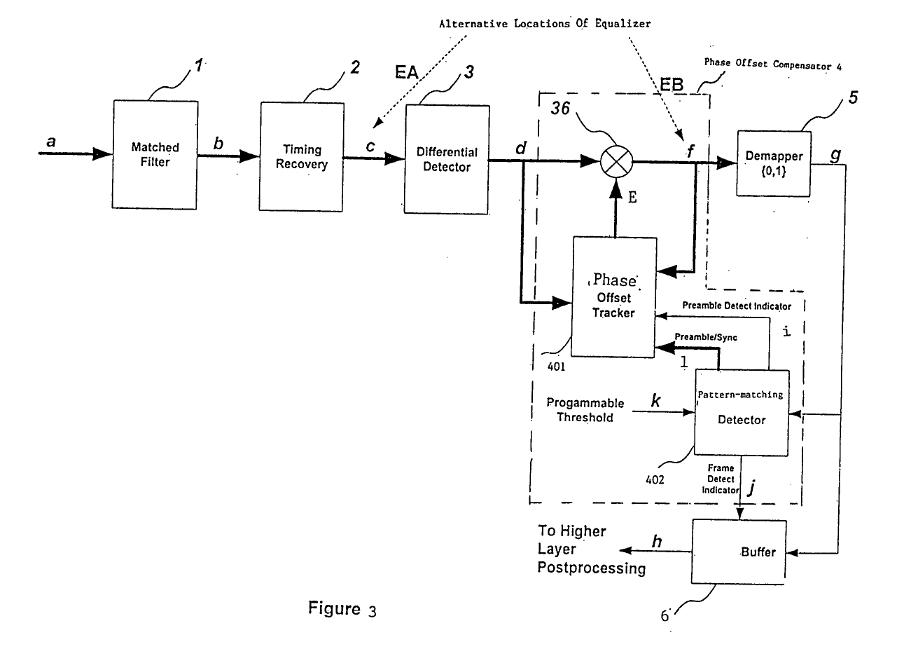

FIG. 3 schematically illustrates a first embodiment of a receiver of the present invention. The received signal (through line a) is first filtered through a Matched Filter 1, typically a square-root-raised cosine filter. The filtered signal (through line b) is then coupled to a Timing Recovery Loop 2. As mentioned before, the Timing Recovery Loop 2 recovers the received symbols so that they are both phase and frequency matched to the transmitter clock. The Timing Recovery Loop 2 outputs the timing-corrected samples at symbol rate to a Differential Detector 3 which multiplies each symbol with a delayed-conjugate version thereof (it performs the operation rₙrₙ₋₁*, wherein * means conjugate operation) to detect the phase difference between the adjacent timing corrected symbols (through line c). A phase offset compensator 4 compensates the phase offset existing in the neighboring detected symbols (through line d) which is caused by the carrier frequency offset due to the Doppler shifting or the inaccuracy of the oscillators in the transmitter and receiver. The phase offset-compensated symbols (through line f) are next decoded into bit streams by a Demapper 5. A buffer 6 which typically is a Random Access Memory (RAM) stores the bit streams from the demapper 5 (through line g). The phase offset compensator 4 further comprises a phase offset tracker 401, a pattern-matching detector 402 and a multiplier 36, wherein, the pattern-matching detector 402 detects the start of the preamble sequence of the bit stream (through line g) from the demapper 5 by pattern matching the bit stream with a pre-stored preamble bit pattern, and triggers the phase offset tracker by an indicator (through line i); the phase offset tracker 401 calculates an average value of the phase offset existing in the adjacent detected symbols and outputs the result to the multiplier 36; and then the detected symbol (through line d) is multiplied with the average value of the phase offset (through line E) by the multiplier 36 to yield phase offset compensated symbols (through line f). The pattern-matching detector 402 further detects the sync word of the bit stream from the demapper 5 by pattern-matching the bit stream with a pre-stored sync bit pattern, and triggers the buffer 6 by an indicator (through line j) to pass the stored data (through line h) to a higher layer for post-processing.

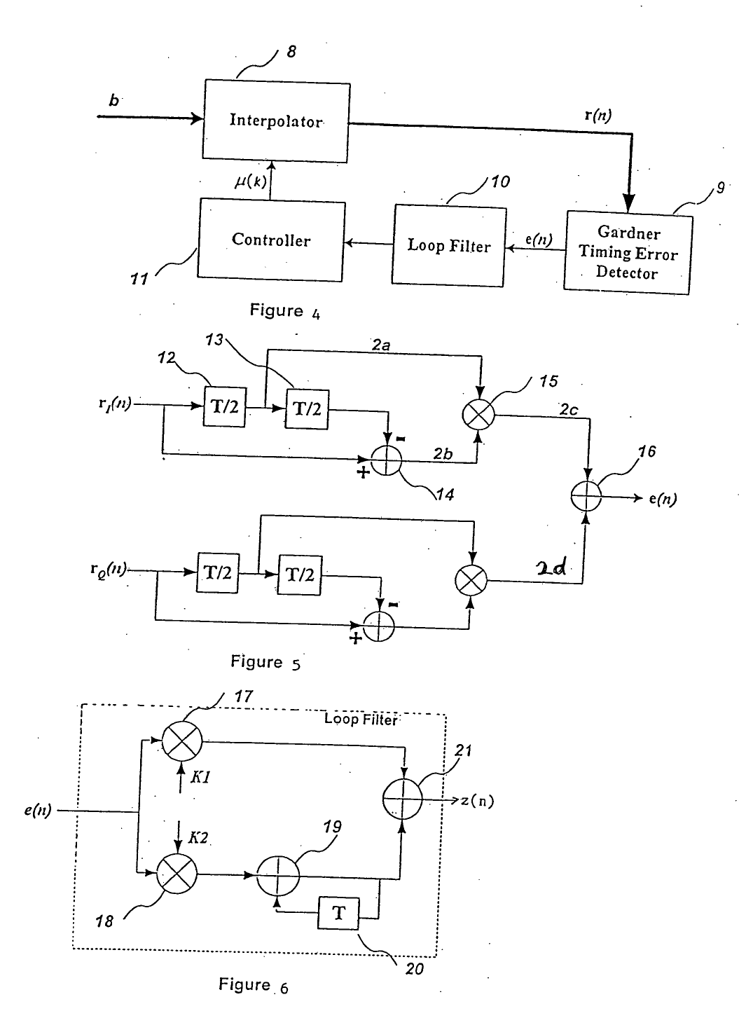

FIG. 4 schematically illustrates an example of a timing recovery loop of the receiver of FIG. 3. The timing recovery loop 2 comprises an Interpolator 8, a Timing Error Detector 9 using a Gardner algorithm, a Loop Filter 10 and a Controller 11.

Based on a feedback controlled signal μ(k) (where, k represents the kₜₕ interpolation point), the interpolator 8 reconstructs the filtered samples (through line b) by interpolating a fractional interval provided by the controller 11 at an interpolation point between neighboring samples and output the timing corrected symbols r(n) (where, n represents the nₜₕ clock tick). The Timing Error detector 9 operates on the interpolated symbols to generate an error signal e(n) that indicates whether the receiver sampling clock phase is advanced or delayed relative to the optimum sampling point. The optimum sampling point being one that is synchronous to the transmitter sampling point. Since the error signal is typically noisy, Loop filter 10 is used to smooth the error signal. In addition, the loop filter also controls the transient response of the timing recovery loop, which is described later. Finally, based on the loop filter output, the controller 11 generates a control signal μ(k), which is known as the “fractional interval”, to the interpolator.

Compared to traditional non-interpolation based timing recovery technique, this timing recovery architecture avoids the requirement of the receiver sampling clock at the Analog Digital Converter (ADC) (not shown in the drawings) to be adjusted so as to be synchronous to the transmitter sampling clock. By using the interpolator to correct for timing and frequency offset after the matched-filter (Note that the ADC is placed before the matched filter 1), feedback elements to the front-end Analog-to-Digital converter for controlling the sampling clock are no longer required. This will not only obviate the need for a Digital-to-Analog converter in the feedback path but also reduce the transport (loop) delay in the typical feedback loop based timing recovery design.

Referring again to FIG. 4, line b represents a complex signal with an oversampling ratio m (e.g. 2 or 4 samples/symbol) that has been filtered by the matched filter 1. Since the timing error detector 9 (the structure of which will be discussed in detail later) in the timing recovery loop 2 requires 2 samples per symbol to operate, the sampling ratio of the match-filtered samples are downsampled to m=2. The downsampling process (not shown in the drawings) is well-known in the art and can be implemented in several ways. For example, a signal can be down sampled by discarding every alternate samples at the match-filter output before getting into the timing-recovery-loop. In digital-signal-processing lexicon, a “divide-by-2 decimator” may be used for the downsampling process. It is typically represented by a box and with a downward-pointing arrow-sign and a “divide-by-2” notation in it. The interpolator 8, fed with control signal μ(k) by the controller 11, reconstructs the samples so that the receiver sampling phase is synchronous with the transmitting symbol clock. The timing error detector 9 feeds a timing error signal to the loop filter 10 which subsequently outputs a filtered signal to the controller 11. The timing error signal which is generated based on the interpolated signals represents the timing error between the received sampling clock and the transmitted clock. When the loop achieves steady state condition, the interpolator 8 generates the timing corrected symbols that are used by the differential detector 3.

FIG. 5 illustrates the structure of the Gardner Timing Error Detector 9 of the timing recovery loop in FIG. 4. The in-phase (r_{I}(n)) and quadrature-phase (r_{Q}(n)) components of the complex signal r(n) (line b in FIG. 3) are fed to the upper and lower arm of the timing error detector 9. The in-phase component (r_{I}(n)) of the complex signal is coupled to a delay element 12 and delay element 13, and the output of 13 is subtracted from the in-phase r_{I}(n) resulting in a subtractor output 2b. The output 2a of delay element 12 and the subtractor output 2b are multiplied by a multiplier 15 to yield result 2c. The multiplier output 2c is summed with its mirror image (lower arm) output 2d by an adder 16 to produce the desired timing error signal e(n).

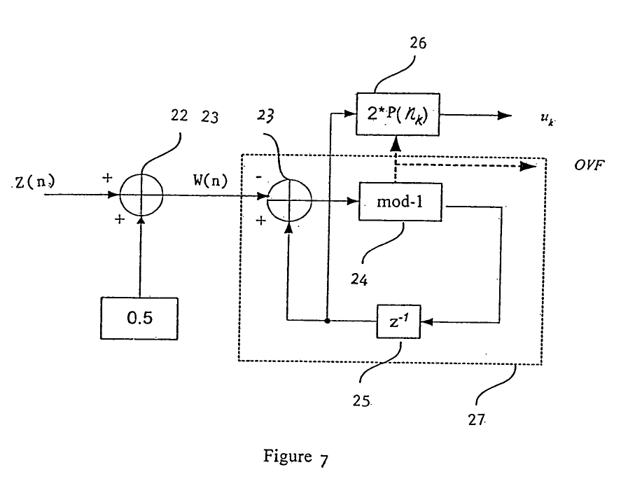

The Loop Filter 10 and Controller 11 are illustrated in FIGS. 6 and 7, respectively. Referring to FIG. 6, the output of the timing error detector 9 is coupled to the respective multipliers 17 and 18. A loop integral constant K2 is applied to multiplier 18 and a loop proportional constant K1 is applied to multiplier 17. These two values can be computed by a system micro-controller in a well-known manner. The output of multiplier 18 is coupled to a first input of an adder 19. The output of adder 19 is coupled to a delay element 20, and the output of the delay element 20 is coupled to the second input of the adder 19. The signal from multiplier 18 is summed in adder 19 with a delayed version of the signal from the delay 20. The output of multiplier 17 is coupled to the first input of adder 21. The output signal from adder 19 is summed in adder 21 with the output of multiplier 17 to yield a loop filtered result z(n).

FIG. 7 illustrates one embodiment of the controller module 11. The loop filter output z(n) is coupled to one input of an adder 22. The adder 22 sums z(n) with a constant coefficient of value 0.5 and outputs a control word W(n) to a modulo-one accumulator 27. Derivation of the constant coefficient is described in the paper “Interpolation in Digital Modems-Part II” by Lars Erup et al. In the accumulator 27, W(n) is fed to one input of a subtractor 23, and the other input thereof is coupled to an output of register 25 which delays an output from a decrementer 24 by a sample clock. The output of subtractor 23 is monitored for underflow condition by the decrementer 24, actually a “mod-1” (modulo-one) counter, which decreases an output from the subtractor 23.

Designating the output of the register 25 at the nₜₕ sampling clock tick as p(n), the modulo-one accumulator 27 has the following difference equation:
p(n)=[p(n−1)−W(n−1)]mod−1

When the decrementer output decreases to less than zero, the decrementer 24 signals a flag OVF to a control signal generator 26 to begin computing a fractional interval or compensation factor μ(k) for the interpolator 8 (FIG. 4):
μ(k)=2*p(nₖ)

The underflow flag OVF is also signaled to the Gardner timing error detector 9 to compute the timing error signal. This flag is also responsible for strobing the interpolator at near optimal timing to yield the timing corrected symbols which are the symbols reconstructed by the interpolator based upon the fractional interval μ(k) provided by the controller 11. Note that the interpolator outputs 2 interpolated samples per symbol as required by the timing error detector 9.

The implementation of interpolator 8 exactly follows the implementations described in the papers by Lars Erup et al. entitled “Interpolation in Digital Modems-Part II”. The interpolator can be based on either a cubic polynomial or a piecewise parabolic function. In practice, the parabolic function is preferred over the cubic polynomial due to the ease of implementation while maintaining performance comparable with other interpolators.

The interpolator can be implemented with a cubic polynomial function or other interpolating functions such as linear and piecewise parabolic functions and in no way do they change the operation of this radio architecture. While an interpolator utilizing a linear parabolic function is less complex than interpolators utilizing the other functions, it also suffers from slightly worst performance. However, the overall BER performance of the linear interpolator is still acceptable particularly for lower order modulation. The interpolator that gives the best BER performance, while offering the least complex implementation, uses the piecewise parabolic function. Hence, the piecewise parabolic function is preferred over other functions in practical implementation, especially for lower-order modulation signals.

FIG. 8 schematically illustrates another example of a timing recovery loop of the receiver shown in FIG. 3. In this example, the matched filter 1 can be placed after the interpolator 8 of the timing recovery loop 2. Because the matched filter 1 is digitally designed with a fixed oversampling ratio, a decimator 1a is introduced to downsample the interpolated samples from the interpolator 8 to a desired oversampling ratio defined by ratio of desired sampling rate and symbol rate for use by the matched filter 1.

This architecture has the advantage of supporting variable symbol-rate transmission where a fixed sampling rate of at least twice the maximum symbol rate is chosen during the analog to digital conversion. Depending on the actual symbol rate, the decimator 1a may be placed right after the interpolator 8 to down-sample the number of interpolated samples to 2 samples per symbol. Thus, a fixed set of filter coefficients can be designed with an over-sampling ratio of 2 samples per symbol while simultaneously supporting multiple symbol-rate transmission.

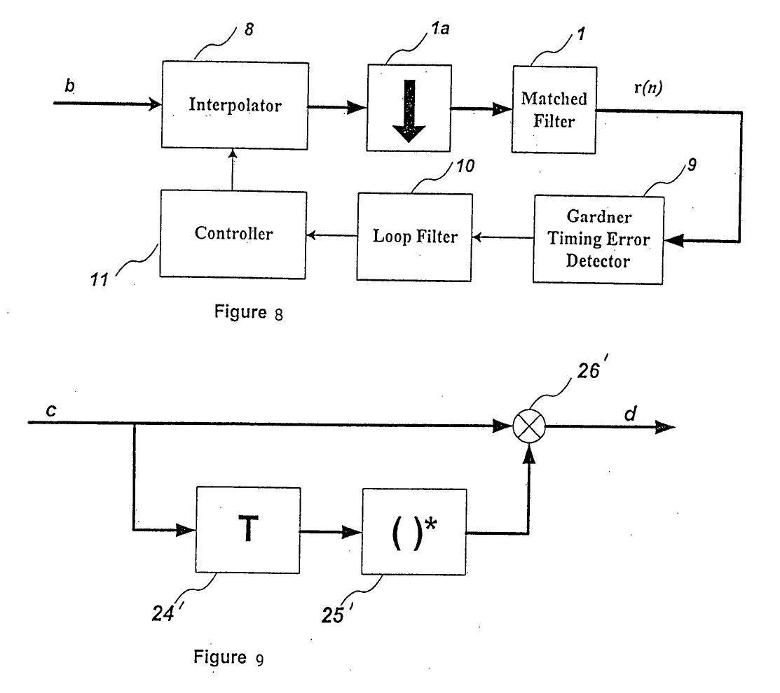

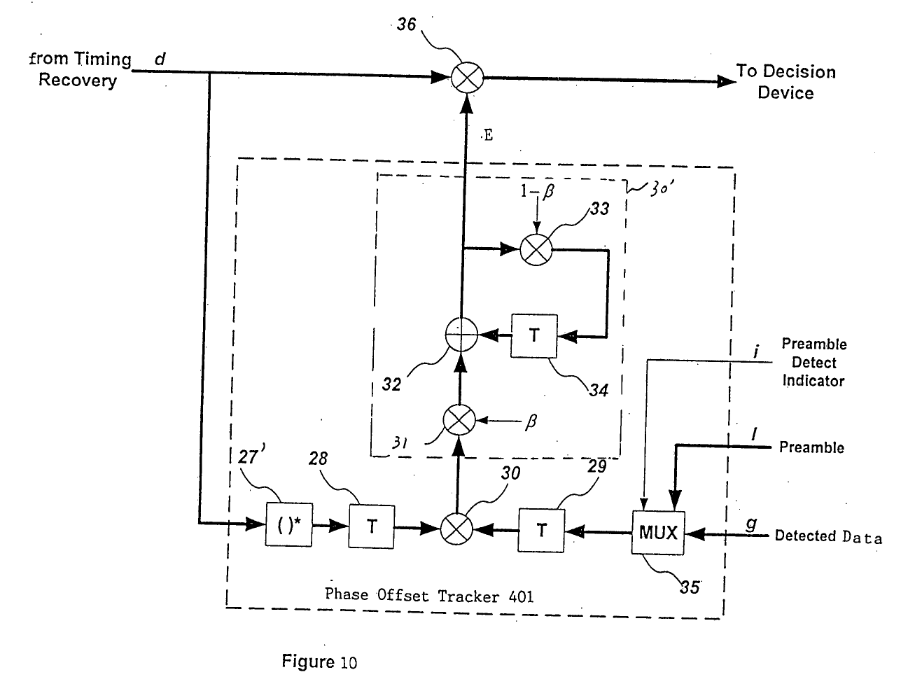

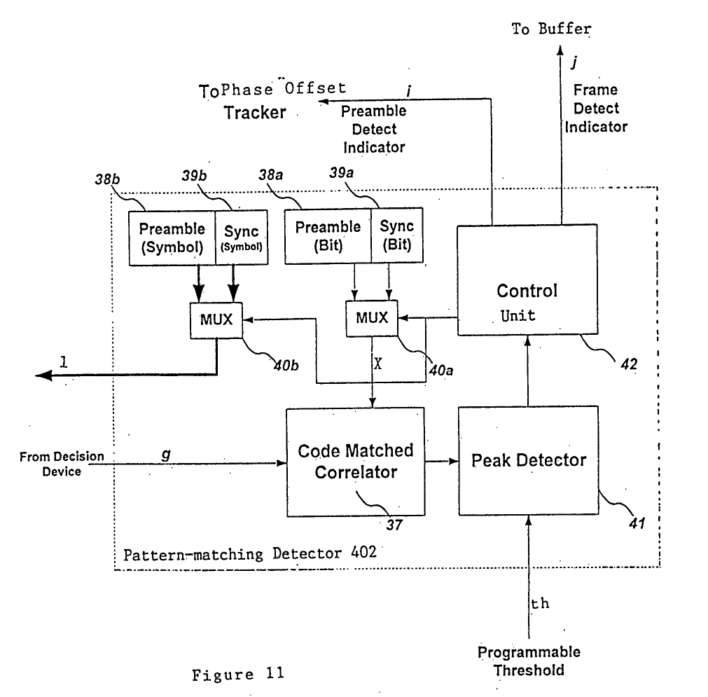

FIG. 9 shows the one-symbol-delay differential detector 3 of the receiver in FIG. 3. The input (through line c) to the differential detector is taken from the output of the timing recovery loop at the symbol rate. A sample at the output of the delay 24′ is conjugated by conjugate operator 25′ prior to the complex multiplier 26′. The output (through line d) is a differential detector output.

FIG. 10 schematically illustrates the structure of a phase-offset tracker 401 implemented as a part of phase offset compensator 4. Line d represents a signal at symbol rate from the Differential Detector 3, which is mathematically represented as c(t) e^{jΔωT}, in which c(t) is a differential detected signal with the packet format shown in FIG. 2, and e^{jΔωT} is a constant phase offset in the neighboring symbols.

Prior to the differential detector 3, the phase offset e^{jΔωt} existing in neighboring symbols, is a rotating term, which makes it difficult to estimate its value. However, after the delay and conjugate operation in the differential detector 3, the running phase offset e^{jΔωt} is converted into a constant phase offset e^{jΔωT}, and therefore, the compensation is performed relatively easily.

The complex conjugate operation is performed on a symbol (through line d) by a conjugate operator 27′. The output of the complex conjugate operator 27′ is delayed by a delay element 28 and is multiplied with a reference signal c(t), which is selected by a multiplexer 35 and then delayed by a delay element 29, in a complex multiplier 30, to yield an output |c(t)|²e^{-jΔωT}, wherein the multiplexer 35 selects the reference signal c(t) from among a preamble/sync word input from the pattern-matching detector 402 (which will be described in detail later) and the output f of the phase offset compensator 4. Due to the Automatic Gain Control (AGC) adjustment on the output |c(t)|²e^{-jΔωT}, which scales the signal to a normalized amplitude of ONE, the input to an average value operator 30′ becomes e^{-jΔωT}. AGC (not shown in the drawings) can be handled both in the analog and digital domain. For example, it may be implemented by a combination of RF and analog (lower frequency) amplifier placed before the analog-to-digital converter to properly scale the signal for conversion. In the average value operator 30′, the multiplier output e^{-jΔωT} is scaled by a real value β in a multiplier 31, and summed 32 with its previous sample from a delay unit 34, scaled by (1−β) in a multiplier 33. The average value of the constant phase offset, E, which is generated by the phase offset tracker 401, compensates the incoming signal d (i.e., the signal c(t) e^{jΔωT}) for the initial large carrier frequency offset. The generated signal E is mixed with the incoming signal d by a complex multiplier 36 to produce a phase offset compensated signal f. The loop is adaptive because the average value operator 30′ continually adjusts the output signal E to cancel any varying frequency offset Δω (drift) in the incoming signal d and fast convergence can be achieved by appropriate selection of scaling factor β (which is determined through simulation study during the design process). The phase offset tracker 401 also corrects for any subsequent carrier frequency drift encounter in the receiver. For short packet length, the phase offset tracker 401 can hold the average value E at the appropriate instant, such as after the phase offset tracker has converged to some value. This process can be achieved by detecting a steady state condition of the output value E.

Here, the phase offset tracker 401 employs a weighting on the current and previous samples as illustrated by the following expression for calculating the average value of the constant phase offset:
Eᵢ=β*eᵢ+(1−β)Eᵢ₋₁

Wherein, a person skilled in the art can derive variations of the technique such as defining multistage adaptation of β wherein β changes progressively. For example, a larger initial value of β results in a faster convergence but higher variance with respect to the actual frequency offset. A smaller β, after the loop converges, allows the tracking of the frequency offset with a smaller variance relative to the actual frequency offset.

An alternative method of calculating the average value allows a variation in the implementation of the phase offset tracker 401. The expression of the phase offset tracker output is given by

$${E}_{i} = {\sum }_{i = 0}^{L - 1} {e}_{i} / L ,$$

in which, the value of L over which the data eᵢ is averaged can be determined empirically.

According to the above alternative method, the complex conjugate operation is performed on sample d. The output of the complex conjugate operator 27′ is delayed by a delay element 28 and is multiplied with a reference signal delayed by a delay element 29 by a complex multiplier 30. The multiplier output is accumulated over L samples in the average value operator 30′. The generated signal E is mixed with the incoming signal d by a complex multiplier 36 to produce a phase offset corrected signal f to compensate the incoming signal d for the initial large carrier frequency offset. The length L affects the accuracy of the frequency offset compensation factor. For the purpose of illustration, L could be chosen to be the length of the preamble sequences.

FIG. 11 schematically illustrates the structure of a pattern-matching detector 402 of the receiver of FIG. 3. The multiplexer 40a receives a control signal from the control unit 42 to output a signal x, which carries either the locally stored Preamble Bits 38a or the Sync Bits 39a, to a code matched correlator 37. The control unit 42 also controls a multiplexer 40b to select either the locally stored Preamble Symbols 38b or the Sync Symbols 39b. The output I of the multiplexer 40b is used by the multiplexer 35 in the phase offset tracker 401 for phase offset compensation.

The correlator 37 correlates the bit stream g from the demapper 5 with the selected bit pattern 38a or 39a, and outputs the number of the correlated bits to a peak detector 41. The peak detector 41 compares the number from the correlator 37 with a programmable threshold th. If the number of the correlated bits is above the programmable threshold th, the peak detector 41 triggers the control unit 42 to output a preamble detect indicator i or a frame detect indicator j to the phase offset tracker 401 and the buffer 6, respectively.

When, under control of the control unit 42, the multiplexer 40a selects the preamble bit pattern 38a and outputs it to the correlator 37, the correlator 37 detects the number of correlated bits between the bit stream from the demapper 5 and the prestored preamble bits 38a and outputs this number to the peak detector 41. The peak detector 41 detects when the number is above the programmable threshold th, and triggers the control unit 42 to output a preamble detect indicator i to the phase offset tracker 401 indicating the presence of the preamble/sync symbols I. However, when, under control of the control unit 42, the multiplexer 40a selects the sync bit pattern 39a and outputs it to the correlator 37, the correlator 37 detects the number of the correlated bits between the bit stream and the prestored sync bits 39a and outputs this number to the peak detector 41. If the peak detector 41 detects that the number is above the programmable threshold th, the peak detector 41 triggers the control unit 42 to output a frame detect indicator j to the buffer 6 indicating the position of a sync word of the buffered data from the demapper 5 for the higher layer postprocessing.

The Code Matched Correlator 37 may be implemented by an exclusive-nor operator. A mathematical representation of the output of the Code Matched Correlator is

$${C}_{K} = {\sum }_{i = 0}^{N - 1} {g}_{k - i} \overline{⊕} {P}_{N - i - 1} \qquad ( 1 )$$

where P is the selected preamble or sync bit pattern with length N, g is the decoded bit stream from the demapper 5 and C_{K} is the number of correlated bits at time K.

As mentioned previously, the phase offset tracker 401 works in parallel with the transmission of the preamble sequence. It should be noted that the operation of the phase offset tracker 401 may still continue in a decision directed mode even after the transmission of the preamble and the sync word. Alternatively, a control signal to the tracker may be used to freeze the computation before the start of the actual payload transmission. This results in power savings as it allows clock gating to be used. The assertion of the control signal to halt computation is readily performed by the pattern-matching detector 402. Namely, when the pattern-matching detector 402 detects the pattern-matching between the bit stream from the demapper 5 and the pre-stored sync bit pattern, it will send the above-mentioned control signal to the phase offset tracker 401 to freeze the operation.

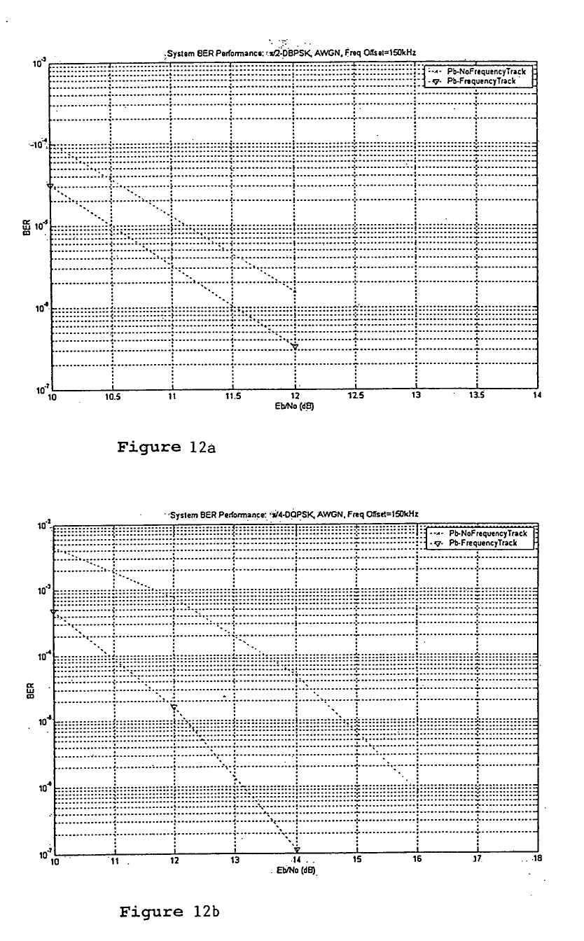

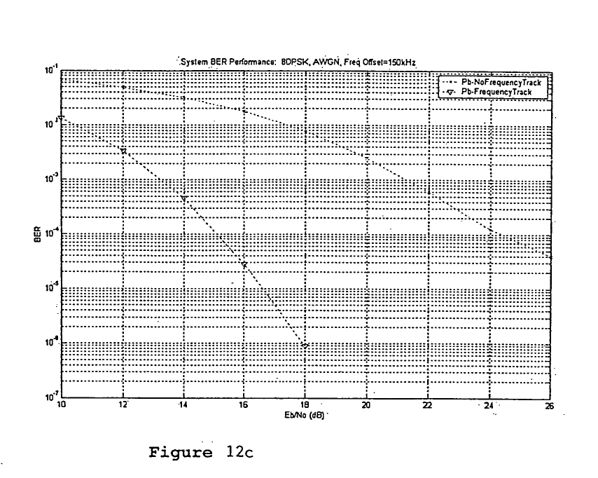

FIGS. 12a, 12b and 12c respectively depict the bit error rate (BER) performances of the system of the present invention using μ/2-DBPSK modulation scheme, π/4-DQPSK modulation scheme and 8DPSK modulation scheme. The simulation parameters and data-packet follow the Bluetooth HighRate Draft Specification V0.5. The symbol rate is 4 MBaud and the frequency offset of 150 kHz is present in the simulation.

In FIGS. 12a-12c, the comparison of the BER performance curves demonstrates that the disclosed techniques successfully mitigate the effect of large frequency offset.

### Second Embodiment

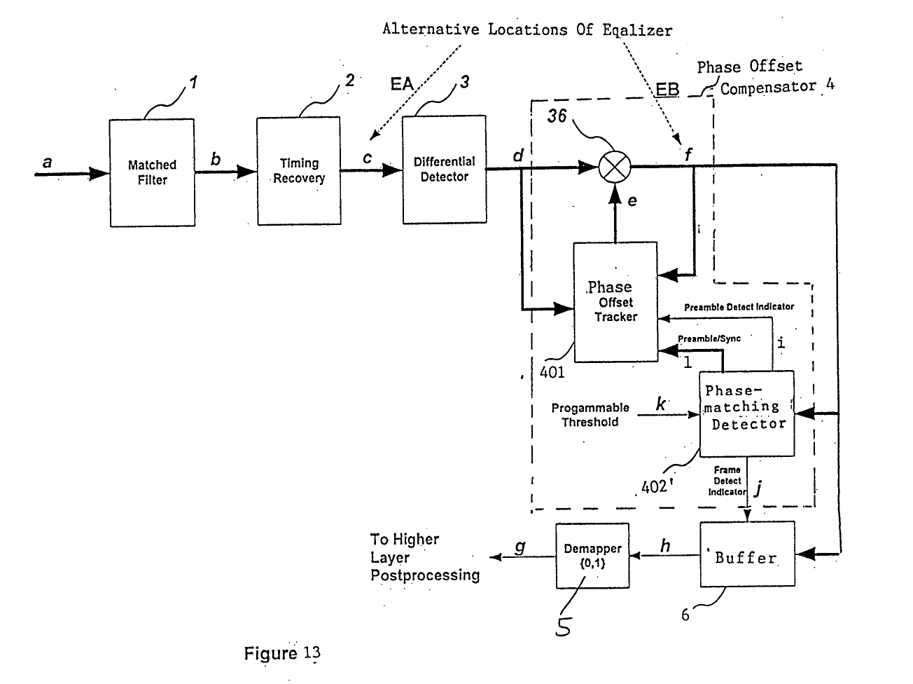

FIG. 13 schematically illustrates a second embodiment of a receiver of the present invention. As shown in FIG. 13, the second embodiment of the receiver includes a matched filter 1 for filtering a received signal to remove the out-of-band noise, a timing recovery module 2 for recovering the filtered signal to output timing corrected symbols, a differential detector 3 for differentially demodulating the timing corrected symbols, a phase offset compensator 4 for compensating the phase offset existing in the neighboring detected symbols which includes a phase offset tracker 401, a phase-matching detector 402′ and a multiplier 36, a buffer 6 for storing the phase offset compensated symbols from the compensator 4 and a demapper 5 for decoding the data from the buffer 6. The difference between the first and second embodiments of the receiver of the present invention is the position of the demapper, and the structure of the phase-matching detector 402′, which is modified accordingly from the pattern matching detector 402 to accommodate the new demapper position.

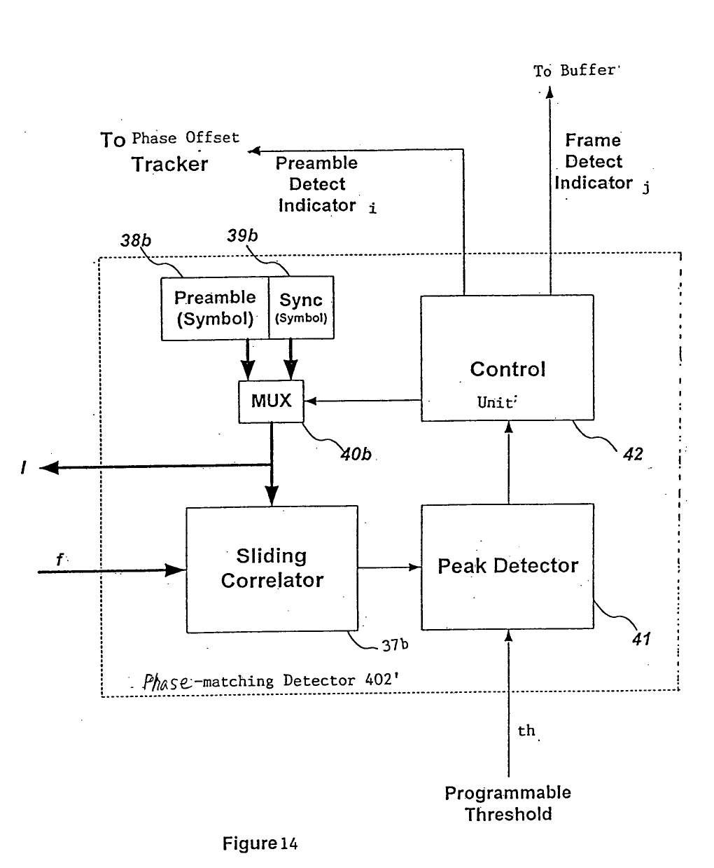

FIG. 14 schematically illustrates the structure of a phase-matching detector of the receiver shown in FIG. 13.

As shown in FIG. 14, the multiplexer 40b receives a control signal from the control unit 42 to output a signal I which carries either the locally stored preamble symbols 38b or the sync symbols 39b. The signal I is output to a sliding correlator 37b and the phase offset-tracker 401. The output I of the multiplexer 40b is used by the multiplexer 35 in the phase offset tracker 401 for phase offset compensation.

The sliding correlator 37b correlates the symbols f from the phase offset compensator 4 with the selected symbols 38b or 39b, and outputs the number of correlated bits to a peak detector 41. The peak detector 41 compares the number from the sliding correlator 37b with a programmable threshold th. If the number of the correlated bits is above the programmable threshold th, the peak detector 41 triggers the control unit 42 to output a preamble detect indicator i or frame detect indicator j to the phase offset tracker 401 and the buffer 6, respectively.

When, under control of the control unit 42, the multiplexer 40b selects the preamble symbols 38b and outputs it to the sliding correlator 37b, the sliding correlator 37b detects the number of correlated bits between the phase-offset compensated symbols f from the phase offset compensator 4 and the prestored preamble symbols 38b and outputs this number to the peak detector 41. The peak detector 41 detects that the number is above the programmable threshold th, and triggers the control unit 42 to output a preamble detect indicator i to the phase offset tracker 401 indicating the presence of the preamble/sync symbols I. However, when, under control of the control unit 42, the multiplexer 40b selects the sync symbols 39b and outputs it to the sliding correlator 37b, and the sliding correlator 37b detects the number of the correlated bits between the symbols f from the compensator 4 and the prestored sync symbols 39b and outputs this number to the peak detector 41. When the peak detector 41 detects that the number is above the programmable threshold th, it triggers the control unit 42 to output a frame detect indicator j to the buffer 6 indicating the position of a sync word of the buffered data f for the higher layer postprocessing.

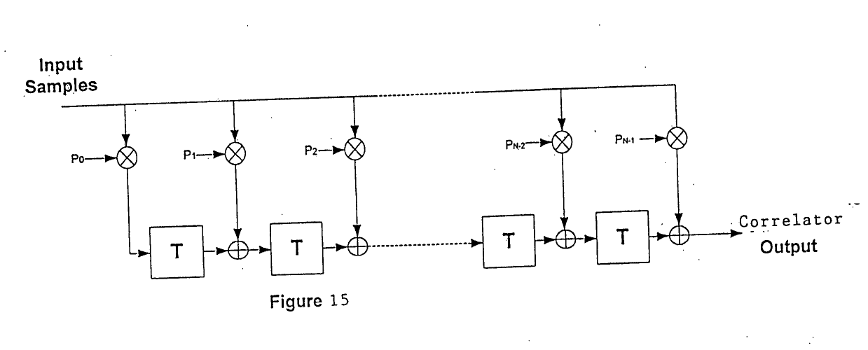

FIG. 15 schematically illustrates the structure of a sliding correlator of the phase-matching detector which is well-known in the art and will not be described in detail here.

The receivers described in the above embodiments also include an equalizer, such as a Linear Equalizer (LE) or a Decision Feedback Equalizer (DFE). The equalizer is in position EA in FIGS. 3 and 13.

For the implementation with an equalizer operating on signal c, the signal from the output of the timing recovery loop 2 passes through the equalizer prior Differential Detector 3. The equalizer can have two additional modes of operation. In one mode the equalizer operates as a symbol-spaced equalizer (SSE) and in another mode the equalizer operates as a fractional spaced equalizer (FSE). The SSE makes use of the recovered symbol from the Timing Recovery Loop, that is, it operates on samples taken symbol-space apart. On the other hand, the FSE does not operate on samples that are symbol-spaced apart, but rather a fraction of a symbol space apart, e.g. half-symbol space. Therefore it makes use of both interpolated output samples provided per symbol span by the Timing Recovery Loop.

The receivers described in the above embodiments also use of equalizers such as Linear Equalizers (LE) or Decision Feedback Equalizers (DFE). The location of the equalizer is EB as indicated in FIGS. 3 and 13.

For the implementation with equalizer operating on signal f, the signal from the output of Differential Detector 3 passes through the compensator 4. The symbol spaced data is processed by the equalizer in front of the Demapper 5.

### INDUSTRIAL APPLICATION

The receiver described in this disclosure can be used with a Continuous Phase Modulation (CPM) scheme which uses a differential detector for demodulation. Two key examples of CPM are the GFSK and GMSK modulation schemes used in Bluetooth and GSM respectively.

The proposed receiver architecture can be applied to any burst packet transmission system that supports M-DPSK and CPM modulation.

The receiver of the present invention utilizes the transmission of a preamble and/or synchronization sequence at the start of the transmission.

One application is in the implementation of a receiver conforming to Bluetooth Medium/High Rate Draft Specification V0.5. In Bluetooth High Rate Draft Specification V0.5, an 8 symbol preamble sequence which is repeated over 9 times constitutes part of the preamble. A 16 symbols synchronization sequence precedes the preamble sequence. In Bluetooth Medium Rate Draft Specification V0.5, a 16 symbol synchronization sequence precedes the payload.

The described embodiments are also very advantageous in low cost, low power consumption wireless personal area network applications.

The described embodiments are also very advantageous in Time Division Multiple access (TDMA) or Time Division Duplex (TDD) communications systems that operate on burst mode where fast carrier acquisition is mandatory for proper operation.

1. A digital radio receiver, comprising:
a filtering and timing recovering means arranged to recover a received signal to produce timing corrected symbols;
a differential detector arranged to differentially detect the timing corrected symbols to provide detected symbols;
phase offset compensation means arranged to compensate for a phase offset in the detected symbols to provide phase offset compensated symbols; and
decoding means arranged to decode the phase offset compensated symbols into bit streams.

2. A digital radio receiver according to claim 1, wherein the received signal comprises-preamble sequences and sync sequences.

3. A digital radio receiver according to claim 1, wherein the phase offset compensation means comprises:
a pattern-matching detector, a phase offset tracker and a multiplier, wherein,
the pattern-matching detector is arranged to trigger the phase offset tracker upon detecting a pattern-matching between the bit stream and a pre-stored bit pattern;
the phase offset tracker calculates an average value of the phase offset; and
the multiplier multiplies the detected symbols with the average value of the phase offset to yield the phase offset compensated symbols.

4. A digital radio receiver according to claim 1, wherein the compensation means comprises:
a phase-matching detector, a phase offset tracker and a multiplier, wherein,
the phase-matching detector is arranged to trigger the phase offset tracker upon detecting a pattern-matching between the phase offset compensated symbols and a pre-stored symbol pattern;
the phase offset tracker is arranged to calculate an average value of the phase offset; and
the multiplier is arranged to multiply the detected symbols with the average value of the phase offset to yield the phase offset compensated symbols.

5. A digital radio receiver according to claim 3, wherein the pattern-matching detector comprises: a first multiplexer, a correlator, a peak detector, a control unit, wherein,
the first multiplexer is arranged to select pre-stored preamble bits or sync bits under control of the control unit;
the correlator is arranged to correlate the bit stream with the selected bits and yield an output representing the number of correlated bits;
the peak detector is arranged to compare the output from the correlator with a threshold and trigger the control unit if the output is above the threshold; and
the control unit is arranged to output a preamble detect indicator to trigger the phase offset tracker and control the first multiplexer to output the selected bits to the phase offset tracker.

6. A digital radio receiver according to claim 3, wherein the pattern-matching detector comprises: a first multiplexer, a second multiplexer, a correlator, a peak detector, a control unit, wherein,
the first multiplexer is arranged to select pre-stored preamble bits or sync bits under control of the control unit;
the correlator is arranged to correlate the bit stream with the selected bits and yields an output representing the number of correlated bits;
the peak detector is arranged to compare the output from the correlator with a threshold and trigger the control unit if the output is above the threshold; and
the control unit is arranged to output a preamble detect indicator to trigger the phase offset tracker and controls the second multiplexer to select a pre-stored preamble symbol or sync symbol to output to the phase offset tracker.

7. A digital radio receiver according to claim 4, wherein the phase-matching detector comprises:
a multiplexer, a control unit, a sliding correlator and a peak detector, wherein:
the multiplexer is arranged to select pre-stored preamble symbols or sync symbols under control of the control unit to provide selected symbols;
the sliding correlator is arranged to correlate the selected symbols with the phase offset compensated symbols to yield an output representing the number of correlated bits;
the peak detector is arranged to compare the output from the sliding correlator with a threshold and trigger the control unit if the output is above the threshold; and
the control unit is arranged to output a preamble detect indicator to trigger the phase offset tracker and control the multiplexer to output the selected symbols to the phase offset tracker.

8. A digital radio receiver according to claim 3, wherein the phase offset tracker comprises:
a complex conjugate operator arranged to complex conjugate the detected symbols to provide a conjugated symbol;
a first delay unit arranged to delay the conjugated symbol to provide a first delayed symbol;
a multiplexer arranged to select a phase offset compensated symbol from the phase offset compensation means or preamble/sync data from the pattern-matching detector to provide a selected symbol;
a second delay unit arranged to delay the selected symbol to provide a second delayed symbol;
a first multiplier arranged to multiply the first delayed symbol with the second delayed symbol to provide a first product;
an average value operator arranged to obtain an average value of the first product.

9. A digital radio receiver according to claim 4, wherein the phase offset tracker comprises:
a complex conjugate operator arranged to complex conjugate the detected symbols to provide a conjugated symbol;
a first delay unit arranged to delay the conjugated symbol to provide a first delayed symbol;
a multiplexer arranged to select a phase offset compensated symbol from the phase offset compensation means or preamble/sync data from the pattern-matching detector to provide a selected symbol;
a second delay unit arranged to delay the selected symbol to provide a second delayed symbol;
a first multiplier arranged to multiply the first delayed symbol with the second delayed symbol to provide a first product;
an average value operator arranged to obtain an average value of the first product.

10. A digital radio receiver according to claim 8, wherein the average value operator comprises a second multiplier, a summer, a delay unit, and a third multiplier,
wherein:
the second multiplier is arranged to multiply the first product with a first parameter to provide a second product;
the third multiplier is arranged to multiply an output from the summer with a second parameter to provide a third product;
the delay unit is arranged to delay the third product to provide a delayed signal; and
the summer is arranged to sum the second product and the delayed signal to provide the average value.

11. A digital radio receiver according to claim 9, wherein the average value operator comprises a second multiplier, a summer, a delay unit, and a third multiplier,
wherein:
the second multiplier is arranged to multiply the first product with a first parameter to provide a second product;
the third multiplier is arranged to multiply an output from the summer with a second parameter to provide a third product;
the delay unit is arranged to delay the third product to provide a delayed signal; and
the summer is arranged to sum the second product and the delayed signal to provide the average value.

12. A digital radio receiver according to claim 3, wherein the phase offset tracker is arranged to stop calculation when the pattern-matching detector detects the pattern-matching between the bit stream/phase offset compensated symbols and the pre-stored sync word.

13. A digital radio receiver according to claim 3, further comprising a buffer arranged to buffer the bit streams from the decoding means for the use in postprocessing.

14. A digital radio receiver according to claim 13, wherein when the pattern-matching detector is arranged to detect a pattern-matching between the bit stream and the pre-stored sync bits, the control unit of the pattern-matching detector outputs an sync detect indicator to the buffer indicating a position of a sync word in the buffered data.

15. A digital radio receiver according to claim 4, further comprising a buffer arranged to buffer the phase offset compensated symbols from the phase offset compensator for the use of the decoding means.

16. A digital radio receiver according to claim 15, wherein when the phase-matching detector is arranged to detect a pattern-matching between the phase offset compensated symbols and the pre-stored sync symbols, the control unit of the phase-matching detector outputs an sync detect indicator to the buffer indicating the position of a sync word of the buffered data.

17. A digital radio receiver according to claim 1, wherein the filtering and timing recovering means comprises:
a filter arranged to filter the received signal to provide filtered samples; and
a timing recovery unit arranged to timing recover the filtered samples to obtain the timing corrected symbols.

18. A digital radio receiver according to claim 17, wherein the timing recovery unit comprises:
an interpolator arranged to interpolate the filtered samples and output the timing corrected symbols;
a timing error detector arranged to generate a timing error signal dependent upon the interpolated signal;
a loop filter arranged to smooth the timing error signal to provide a filtered timing error signal;
a controller arranged to process the filtered timing error signal to obtain a control signal to control the interpolator to interpolate and output the timing corrected symbols.

19. A digital radio receiver according to claim 1, wherein the filtering and timing recovering means comprises:
an interpolator arranged to interpolate samples of the received signal and output timing corrected samples;
a decimator arranged to downsample the timing corrected samples into timing corrected symbols;
a matched filter arranged to filter the timing corrected symbols to provide filtered symbols;
a timing error detector arranged to generate a timing error signal indicating the timing difference between the receiver sampling clock and the transmitter sampling clock dependent upon the filtered symbols;
a loop filter arranged to smooth the timing error signal to provide a filtered timing error signal;
a controller arranged to process the filtered timing error signal to obtain a control signal to control the interpolator to interpolate and output the timing corrected samples.

20. A digital radio receiver according to claim 18, wherein the controller comprises: an adder, a subtractor, a decrementer, a register, and a control signal generator, wherein
the adder is arranged to sum the filtered timing error signal and a pre-set coefficient to provide a sum;
the subtractor is arranged to subtract the sum from an output of the register to provide a difference signal;
the decrementer is arranged to decrease the difference signal and send an underflow signal to the control signal generator when the result reaches zero;
the control signal generator is arranged to generate a control signal to the interpolator on receiving the underflow signal.

21. A digital radio receiver according to claim 19, wherein the controller comprises: an adder, a subtractor, a decrementer, a register, and a control signal generator, wherein
the adder is arranged to sum the filtered timing error signal and a pre-set coefficient to provide a sum;
the subtractor is arranged to subtract the sum from an output of the register to provide a difference signal;
the decrementer is arranged to decrease the difference signal and send an underflow signal to the control signal generator when the result reaches zero;
the control signal generator is arranged to generate a control signal to the interpolator on receiving the underflow signal.

22. A digital radio receiver according to claim 1, further comprising an equalizer coupled to the filtering and timing recovering means arranged to equalize the inter-symbol interference of the timing corrected symbols.

23. A digital radio receiver according to claim 1, further comprising an equalizer coupled to the output of the phase offset compensator arranged to equalize the inter-symbol interference of the phase offset compensated symbols.
